(19) United States
(12) Patent Application Publication
(10) Pub. No.: US 2014/0159893 A1
(43) Pub. Date: Jun. 12, 2014

(54) BRACELET TRACKING SYSTEM

(71) Applicants: Shannon Housley, Hayward, CA (US); Glenda Housley, Hayward, WA (US)

(72) Inventors: Shannon Housley, Hayward, CA (US); Glenda Housley, Hayward, WA (US)

(21) Appl. No.: 13/708,178

(22) Filed: Dec. 7, 2012

(51) Int. Cl. G08B 21/02

(52) U.S. Cl. CPC G08B 21/02
USPC 340/539.13

(57) ABSTRACT

The present invention is a bracelet tracking system that includes a caregiver monitoring bracelet worn by one or more caregivers, the caregiver monitoring bracelet includes a base caregiver bracelet, a digital display, an increasing display button, a decreasing display button, a first call alarm, an automatic reset button, one or more first indicator lights and a GPS receiver. The system also includes a caretaker tracking device worn by one or more caretakers, the caretaker device includes a base caretaker ring, a second call alarm, one or more second indicator lights and a GPS transmitter and a communications technology that puts the caregiver monitoring bracelet in communication with the one or more caregiver tracking devices.

### TECHNICAL FIELD & BACKGROUND

Adults and children are frequently in environments or situations where they may become separated. The separation may be inadvertent or voluntary, in either case, a parent or guardian often desires to locate the child quickly to verify their safety.

The present invention generally relates to a tracking system. More specifically, the invention is a bracelet tracking system.

It is an object of the invention to provide a bracelet tracking system that allows a parent to track a child, an elderly person, a special needs person or an animal.

It is an object of the invention to provide a bracelet tracking system that utilizes a plurality of attachments as part of the tracking components of the bracelet tracking system.

It is an object of the invention to provide a bracelet tracking system that is waterproof and can be used at a beach, at a lake or in a pool area

What is really needed is a bracelet tracking system that allows a parent to track a child, an elderly person, a special needs person or an animal that utilizes a plurality of attachments as part of the tracking components of the bracelet tracking system that is waterproof and can be used at a beach, at a lake or in a pool area.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an environmental perspective view of a bracelet tracking system, according to an embodiment of the present invention.

FIG. 2 illustrates a front perspective view of a bracelet tracking system, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

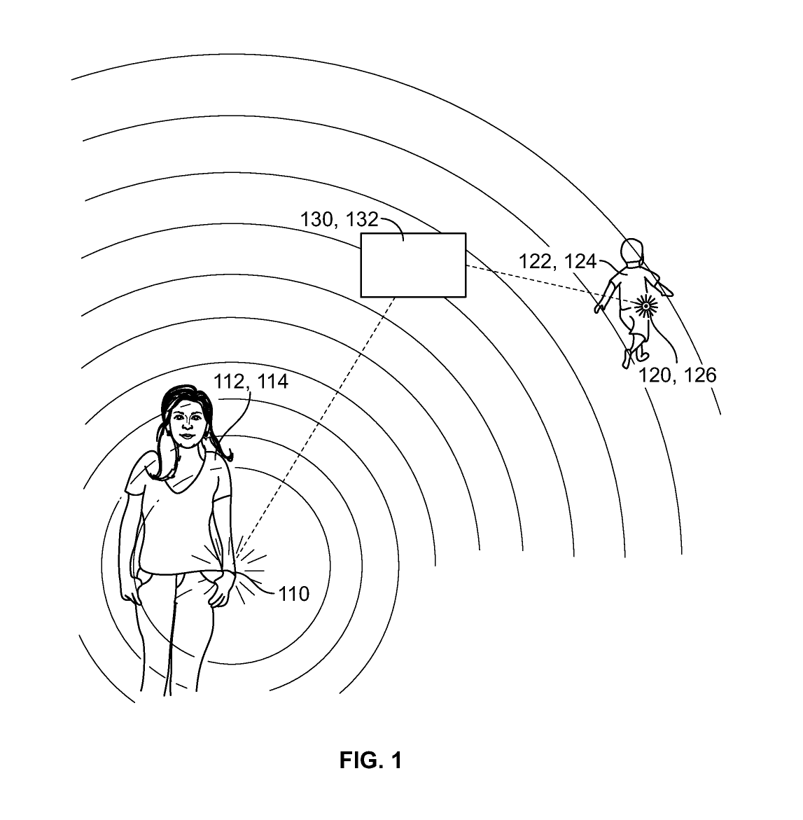

FIG. 1 illustrates an environmental perspective view of a bracelet tracking system 100, according to an embodiment of the present invention.

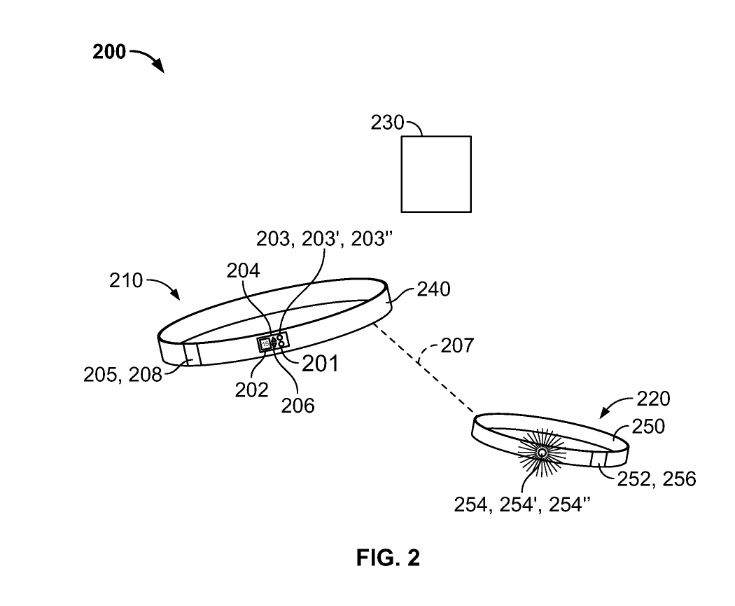

The bracelet tracking system 100 includes a caregiver monitoring bracelet 110, a caretaker tracking device 120 and a communications technology 130. The caregiver monitoring bracelet 110 is worn by one or more caregivers 112. FIG. 1 illustrates one caregiver 112 wearing the caregiver monitoring bracelet 110. The caregiver 112 is typically a parent 114 but can be any suitable caregiver such as a babysitter, a pet owner, a healthcare worker or any other suitable caregiver. Additional details regarding the caregiver monitoring bracelet 110 are illustrated and described in FIG. 2 and its description. The caretaker tracking device 120 is worn by one or more caretakers 122. The caretaker 122 is typically a child 124, as is illustrated in FIG. 1, but can be any suitable caretaker such as a pet, an elderly person or a special needs person. The caretaker tracking device 120 can be a ring 126, as is illustrated in FIG. 1, or other suitable object such as a monetary clip, a piece of clothing or a shoelace. Both the caregiver monitoring bracelet 110 and the caretaker tracking device 120 are waterproof and can be utilized at a suitable body of water and its vicinity such as a beach, a lake or a pool area. Additional details regarding the caregiver tracking device 120 are illustrated and described in FIG. 2 and its description. The communications technology 130 puts the caregiver monitoring bracelet 110 in communication with the one or more caregiver tracking devices 120. The communications technology 130 is typically a global positioning system or GPS technology 132 however any suitable communications technology can be utilized with the bracelet tracking system 100. Additional details regarding the communications technology 130 are illustrated and described in FIG. 2 and its description.

FIG. 2 illustrates a front view of a bracelet tracking system 200, according to an embodiment of the present invention. The bracelet tracking system 200 illustrated and described in FIG. 2 is similar to the bracelet tracking system 100 illustrated and described in FIG. 1. The bracelet tracking system 200 illustrated and described in FIG. 2 includes a caregiver monitoring bracelet 210, a caretaker tracking device 220 and a communications technology 230 that are similar to the caregiver monitoring bracelet 110, the caretaker tracking device 120 and the communications technology 130 illustrated and described in FIG. 1.

The bracelet tracking system 200 additionally includes a base caregiver bracelet 240 and a base caretaker ring 250. The base caregiver bracelet 240 is the bracelet portion of the caregiver monitoring bracelet 210. The base caregiver bracelet 240 includes a digital display 202, an increasing display button 204, a decreasing display button 206, a first call alarm 208, an automatic reset button 201, one or more first indicator lights 203 and a GPS receiver 205. The digital display 202 is disposed on the base caregiver bracelet 240 and displays a predetermined distance limit 207 that is incorporated by the bracelet tracking system 200. The predetermined distance limit 207 can be set at approximately 15 feet, 30 feet, 50 feet or any other suitable distance. The increasing display button 204 is disposed on the base caregiver bracelet 240 and can be depressed to increase the predetermined distance limit 207. The decreasing display button 206 is disposed on the base caregiver bracelet 240 and can be depressed to decrease the predetermined distance limit 205. The first call alarm 208 is disposed on the base caregiver bracelet 240 and is activated when the predetermined distance limit 207 is exceeded. The automatic reset button 201 is disposed on the base caregiver bracelet 240 and resets the first call alarm 208 when the predetermined distance limit 207 is exceeded and the first call alarm 208 is activated. The one or more first indicator lights 203 are disposed on the base caregiver bracelet 240 and are activated when the predetermined distance limit 207 is exceeded and the first call alarm 208 is activated. The one or more first indicator lights 203 can be one or more light-emitting diode or LED lights 203′, one or more liquid crystal display or LCD lights 203″ or other suitable type of indicator light. The GPS receiver 205 is disposed on the base caregiver bracelet 240 and is a component of the communications technology 230.

The base caretaker ring 250 is the ring portion of the caretaker tracking device 220. The base caretaker ring 250 includes a second call alarm 252, one or more second indicator lights 254 and a GPS transmitter 256. The second call alarm 252 disposed on the base caretaker ring 250 is activated when the caretaker tracking device 220 exceeds the predetermined distance limit 207. The one or more second indicator lights 254 are disposed on the base caregiver ring 250 and are activated when the predetermined distance limit 207 is exceeded and the second call alarm 252 is activated. The one or more second indicator lights 254 can be one or more light-emitting diode or LED lights 254′, one or more liquid crystal display or LCD lights 254″ or other suitable type of indicator light. The GPS transmitter 256 transmits a GPS signal that is received by the GPS receiver 205 to indicate that the base caretaker ring 250 and is activated when the predetermined distance limit 207 is exceeded. The GPS transmitter 256 is disposed on the base caretaker ring 250 and is a component of the communications technology 230. The caregiver monitoring bracelet 210 and the caretaker tracking device 220 also are battery powered.

The bracelet tracking system is a child tracking and locating device. The bracelet tracking system includes a bracelet with a set of command features for an adult or other supervisory person to wear, as well as an attachable device for a child. The child's device will begin to flash its lights and emit an alarm sound in order to alert the parent or caregiver if the child exceeds a predetermined distance from the adult's unit. The bracelet tracking system may be readily available in a variety of colors as well as interchangeable attachments for more than one child and is well-suited for dogs, special needs individuals, the elderly and the like.

The bracelet tracking system features two battery powered components which work in relation to their proximity to one another, that include a set of predetermined distances for activation such as 15 feet, 30 feet and 50 feet. The bracelet tracking system is designed to be waterproof and emit powerful vibrations in addition to alarm sounds and lights, in order to accommodate hearing impaired persons.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A bracelet tracking system, comprising:
a caregiver monitoring bracelet worn by one or more caregivers, said caregiver monitoring bracelet includes a base caregiver bracelet, a digital display, an increasing display button, a decreasing display button, a first call alarm, an automatic reset button, one or more first indicator lights and a GPS receiver, said digital display is disposed on said base caregiver bracelet and displays a predetermined distance limit;
a caretaker tracking device worn by one or more caretakers, said caretaker device includes a base caretaker ring, a second call alarm, one or more second indicator lights and a GPS transmitter; and
a communications technology that puts said caregiver monitoring bracelet in communication with said one or more caregiver tracking devices.

2. The bracelet tracking system according to claim 1, wherein said caregiver is a parent.

3. The bracelet tracking system according to claim 1, wherein said predetermined distance limit is set at a selected one of approximately 15 feet, 30 feet and 50 feet.

4. The bracelet tracking system according to claim 1, wherein said increasing display button is disposed on said base caregiver bracelet, said increasing display button is depressed to increase said predetermined distance limit.

5. The bracelet tracking system according to claim 1, wherein said decreasing display button is disposed on said base caregiver bracelet, said decreasing display button is depressed to decrease said predetermined distance limit.

6. The bracelet tracking system according to claim 1, wherein said first call alarm is disposed on said base caregiver bracelet.

7. The bracelet tracking system according to claim 7, wherein said first call alarm is activated when said predetermined distance limit is exceeded.

8. The bracelet tracking system according to claim 1, wherein said caretaker is a child.

9. The bracelet tracking system according to claim 1, wherein said caregiver monitoring bracelet and said caretaker tracking device is waterproof.

10. The bracelet tracking system according to claim 1, wherein said caregiver monitoring bracelet and said caretaker tracking device are battery powered.

11. The bracelet tracking system according to claim 1, wherein said reset button is disposed on said base caregiver bracelet, said reset button resets said first call alarm when said predetermined distance limit is exceeded and said first call alarm is activated.

12. The bracelet tracking system according to claim 1, wherein said one or more first indicator lights are disposed on said base caregiver bracelet, said one or more first indicator lights are activated when said predetermined distance limit is exceeded and said first call alarm is activated.

13. The bracelet tracking system according to claim 1, wherein said one or more first indicator lights is a selected one of one or more light-emitting diode lights and one or more liquid crystal display lights.

14. The bracelet tracking system according to claim 1, wherein said GPS receiver is disposed on said base caregiver bracelet.

15. The bracelet tracking system according to claim 1, wherein said second call alarm disposed on said base caretaker ring is activated when said caretaker tracking device exceeds said predetermined distance limit.

16. The bracelet tracking system according to claim 1, wherein said one or more second indicator lights are disposed on said base caregiver ring, said one or more second indicator lights are activated when said predetermined distance limit is exceeded and said second call alarm is activated.

17. The bracelet tracking system according to claim 1, wherein said one or more second indicator lights is a selected one of one or more light-emitting diode lights and one or more liquid crystal display lights.

18. The bracelet tracking system according to claim 1, wherein said GPS transmitter transmits a GPS signal that is received by said GPS receiver to indicate that said base caretaker ring is activated when said predetermined distance limit is exceeded.

19. The bracelet tracking system according to claim 1, wherein said GPS transmitter is disposed on said base caretaker ring.

20. The bracelet tracking system according to claim 1, wherein said communications technology is a global positioning system technology.
